(19) United States
(12) Patent Application Publication
(10) Pub. No.: US 2015/0073869 A1
(43) Pub. Date: Mar. 12, 2015

(54) SYSTEMS AND METHODS FOR PREDICTING CONSUMER BEHAVIOR

(71) Applicants: Teik L. Tung, Danbury, CT (US); Heather Kowalczyk, Oakland, NJ (US)

(72) Inventors: Teik L. Tung, Danbury, CT (US); Heather Kowalczyk, Oakland, NJ (US)

(73) Assignee: MASTERCARD INTERNATIONAL INCORPORATED, Purchase, NY (US)

(21) Appl. No.: 14/021,232

(22) Filed: Sep. 9, 2013

(51) Int. Cl. G06Q 30/02

(52) U.S. Cl. CPC G06Q 30/0203
USPC 705/7.32

(57) ABSTRACT

Systems and processes are described for providing improved understanding of cardholder purchasing behavior, and/or for providing improved predictions of future consumer needs. In some embodiments, the payment card account receipts of panel respondents are matched to their survey question responses and processed to generate actual spending behavior data, which may then be analyzed to generate one or more predictions concerning future consumer spending behavior. In an implementation, a computer receives recent payment card account receipt data and self-reported survey data of a panel respondent member, tags that data with a unique cardholder identifier (ID), and determines that there is a match between the recent payment card account receipt data and data stored in a transactional cardholder database. The computer then selects a portion of the matched payment card account receipt data corresponding to a time period specified in the self-reported survey data, and generates a cardholder report including a comparison of the self-reported survey data to the selected receipt data that represents actual cardholder purchasing behavior.

### FIELD OF THE INVENTION

Embodiments disclosed herein generally relate to systems and techniques for predicting consumer behavior. In some embodiments, responses to survey questions provided by panel respondents are matched to the payment card account receipts of those panel respondents and processed to generate actual spending behavior data, which is then analyzed to generate one or more predictions concerning future spending behavior.

### BACKGROUND

Businesses are interested in understanding consumers to ensure that their offerings (products and/or services) meet consumer needs, and to identify opportunities for growth. Payment card account companies, such as MasterCard International Incorporated, typically have access to a transactional cardholder database that includes purchasing data of their cardholders. Such cardholder purchasing data does not include any consumer identification data or personal data, but does include payment card account numbers, purchase transaction data (such as the dollar amount and the date and time of the transaction), and merchant information, and this data can be processed to generate predictive modeling behavior data and other consumer analysis data. However, such consumer data analysis is limited because the consumers are not identifiable. Thus, the various types of modeling can only provide a prediction or an approximation of consumer profiles because specific demographic data such as a consumer's age, family size and geographic location (residence address) cannot be derived and thus cannot be used in the consumer analysis. Accordingly, many of the consumer predictions regarding future spending behavior tend to include a fairly large margin of error, which makes it difficult for businesses to rely on such consumer prediction information.

In an effort to obtain better and/or more accurate consumer behavior models, marketing companies utilize consumer surveys provided to consumers who have agreed to participate in such surveys. In some cases, marketing companies form one or more diverse panels of consumers who agree to provide answers to one or more surveys over time. The consumers may all have one or more traits in common, such as being payment card account cardholders of a particular financial services corporation, such as MasterCard International Incorporated. The consumer panel members agree to respond to survey questions on such topics as their shopping behavior, where they go to find new products, how they research and compare products, how they use the products and the factors that drive their decision making and path to purchase. In some cases, the market research company compensates each consumer or cardholder panel member for responding to survey questions, for example, by providing them with gifts, discount coupons, and/or vouchers and the like for products and/or services of their clients.

A marketing company may analyze consumer panel member survey responses to produce reports for businesses regarding insights into who their consumers are, and their attitudes and behaviors across channels. For example, a restaurant client of the marketing company may wish to know: “What percent of Americans that have two or more adults living in the household visit our Hot Dog Heaven restaurants each month?” Since the marketing company cannot divulge personal consumer information, only a general answer can be provided to such specific questions, which is based on the responses from a plurality of the consumer panel members. Thus, for example, in response to the survey question posed above, Hot Dog Heaven would be provided with a percentage of Americans who visit their restaurants each month and the percent of those people who like specific items, based on survey responses received from consumer panel members. In order to tell Hot Dog Heaven the demographic makeup of the households in a survey, the marketing company may use general demographic household information provided by the consumer panel members, but again such information is of a general nature.

Marketing companies also may provide consultancy services based on continuous audits and analyses of consumer purchasing decisions and behavior, which purportedly can be used by a business to make marketing, trade and sales decisions. However, in practice such marketing company services have proven to be subject to fairly large margins of error, making their value questionable to businesses.

The present inventors recognized that there is a need for systems and processes to provide businesses with more accurate and reliable consumer data so that the businesses can better understand and serve various consumer segments.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate exemplary embodiments and which are not necessarily drawn to scale, wherein:

FIG. 1 is a block diagram of a receipt harvesting system according to the invention;

FIG. 2 is a flowchart of a consumer receipt harvesting process in accordance with some embodiments of the invention; and

FIG. 3 is a block diagram of an embodiment of a cardholder modeling server computer according to an embodiment of the invention.

### DETAILED DESCRIPTION

Reference will now be made in detail to various embodiments of the invention. Examples of these embodiments are illustrated in the accompanying drawings, and it should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

In general, and for the purpose of introducing concepts of novel embodiments described herein, described are systems and processes for harvesting cardholder receipts to better understand cardholder purchasing behavior, and/or to better predict future cardholder needs, and/or to supplement cardholder modeling capabilities, and/or to create new products for cardholders. In some embodiments, a cardholder modeling computer is configured for receiving recent payment card account receipt data and self-reported survey data of a cardholder panel respondent member who agreed to provide such data, and for tagging the data with a unique cardholder identifier (ID). The process includes matching the recent payment card account receipt data to historical payment card account data stored in a transactional cardholder database, and then comparing a selected portion of the historical payment card account data (which may be based on a time period, such as a holiday period) to the self-reported survey data. The self-reported survey data that is used for the comparison may include cardholder responses to survey questions that occurred in the past and that concerned consumer purchasing behavior. The computer then generates a cardholder report identified by the unique cardholder ID that correlates the selected portion of the historical payment card account data to the self-reported survey data. The cardholder report may be aggregated or combined with other cardholder reports and then filtered to generate consumer segment data, and the consumer segments may be based on demographic data, economic data, and/or geographic data and the like.

A number of terms will be used herein. The use of such terms are not intended to be limiting, but rather are used for convenience and ease of exposition. For example, as used herein, the term “cardholder” may be used interchangeably with the term “consumer” and are used herein to refer to a consumer, individual, business or other entity that has been issued (or authorized to use) a financial account such as a payment card account (such as a credit card or debit card account). The financial account may be accessed by use of a “payment card” or “payment device” such as a traditional plastic magnetic stripe card, a chip card (such as an EMV card) or a radio-frequency identification (RFID) card (such as a PayPass™ card) or other type of contactless payment card. Pursuant to some embodiments, as used herein, the term “payment card” or “payment device” may also include a mobile device (such as a mobile telephone, a smartphone, a tablet computer, and/or a personal digital assistant) configured for operating a payment application that includes stored payment account information.

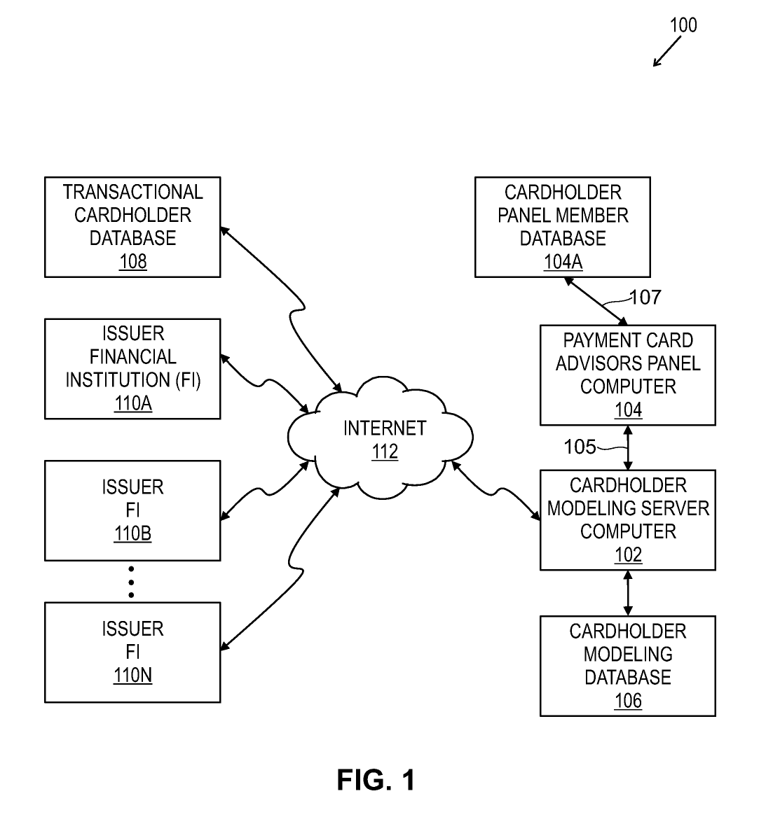

FIG. 1 is a block diagram of a receipt harvesting system 100 according to an embodiment. The system 100 includes a cardholder modeling server computer 102, a payment card advisors panel computer 104, a cardholder panel member database 104A, a cardholder modeling database 106, a transaction cardholder database 108, and a plurality of issuer financial institution (FI) computers 110A, 110B to 110N. The cardholder modeling server computer 102 may be configured to communicate with the payment card advisors panel computer 104 over a secure communications channel 105, which may be secure network connection for example. The cardholder modeling computer 102 may also be configured to access the transaction cardholder database 108 via the internet 112 (or via another network or via a secure connection, not shown) to obtain historical cardholder payment card transaction data stored therein, and may also be configured to communicate with one or more of the plurality of issuer financial institutions (FIs) computers 110A, 110B, and/or 110N. The issuer FI computers 110A, 110B to 110N may be associated with, for example, banks that issue financial accounts (such as credit card accounts, debit card accounts and the like) to consumers.

The cardholder modeling server computer 102 and/or the transactional cardholder database 108 may be owned and/or operated by a payment card account processing company, such as MasterCard International Incorporated, whereas the payment card advisors panel computer 104 may be owned and/or operated by a third party market research company, such as Ipsos, of Paris, France. In the example receipt harvesting system 100 of FIG. 1, the payment card advisors panel computer 104 is connected to a cardholder panel database 104A over a secure connection 107. The cardholder panel database 104A includes data associated with a plurality of cardholders who all agreed to become survey panel members and thus to provide responses to survey questions. For example, the market research company may engage consumers to become cardholder panel members who all are MasterCard® payment card account holders. The market research company contracts with the cardholder panel members and promises to protect all of their personal data and not divulge any personal data to any third parties without consent of the cardholder. When a cardholder enrolls as a panel member, the cardholder provides personal data such as name, age, gender, education level, occupation, residence address, telephone number(s), family member data, income level, and the like to the market research company. The consumer's contact information is used by the marketing company to notify the consumer when there is a new survey opportunity or, for example, to communicate cardholder panel member news. In some cases, the market research company compensates each consumer or cardholder panel member for responding to survey questions, for example, by providing them with gifts, discount coupons, and/or vouchers and the like for products and/or services of their clients.

The market research company thus obtains panel member response data and may generate one or more reports tailored to their clients that concern consumer spending habits, expected future purchases, advertising effectiveness, brand loyalty and the like. These reports may then be sold to clients such as payment processing companies and various financial institutions (such as credit card account issuer banks) In other cases, the market research companies may sell or otherwise provide the cardholder survey response data directly to clients (without including any consumer personal data) for use by the clients to formulate their own reports and/or predictions and/or conclusions regarding cardholder purchasing behavior and the like.

Referring again to FIG. 1, in accordance with novel processes described herein, a method may include a marketing research company, for example, inviting consumers who already are members of a payment card advisors panel to opt-in to a receipt-harvesting service. If a cardholder agrees to participate (opt-in) then that cardholder agrees to respond to survey questions and to provide the marketing research company with recent payment card account receipt data (corresponding to recent purchase transactions). In some implementations, the market research company provides some form of compensation (such as a nominal fee, and/or coupons, and/or vouchers for goods or services) to each cardholder panel member. The marketing research company is also permitted by the cardholder to provide a limited amount of that cardholder's personal data along with that cardholder's self-reported survey data to, for example, a third party payment card network operator. In some implementations, the limited cardholder personal data may include the consumer's age, education level, income, number of family members and geographic location. Information that may be specifically excluded from the limited cardholder personal data are the cardholder's name, address, telephone number and/or other direct contact information.

Once a cardholder opts-in to the receipt-harvesting service, the payment card advisors panel computer 104 (operated by the marketing company) may access the cardholder panel member database 104A and extract the limited cardholder personal data and self-reported survey data associated with that panel member. The payment card advisors panel computer 104 then can transmit the recent payment card account receipt data and the cardholder data extracted from the cardholder panel member database to the cardholder modeling computer 102 for processing. The cardholder modeling computer 102 tags the extracted cardholder data and associated recent payment card account receipt data with a unique cardholder identifier (ID), and in some implementations stores that data with the unique cardholder ID in the cardholder modeling database 106. Next, in some embodiments, the cardholder modeling computer 102 communicates via a secure network (not shown) with the transactional cardholder database 108. Such a secure network may be operated and maintained by, for example, a payment card processing company like MasterCard International Incorporated.

The transactional cardholder database 108 stores all purchase transaction information associated with the cardholder accounts of, for example, a credit card network company (such as MasterCard International Incorporated) issued in a specific region, such as North America that occurred during a specific time period (such as Jan. 1, 2012 to Dec. 31, 2012). Thus, it should be understood that, in some embodiments the transactional cardholder database 108 may include a plurality of databases, and each database may contain cardholder data that corresponds to purchase transaction activity from one or more regions and/or countries and/or territories. For example, an entry concerning a particular cardholder purchase transaction may include cardholder account number data, the date and time of a purchase transaction, the amount of the purchase transaction, and a merchant identifier. Such purchase transaction data does not include any personal cardholder data.

Referring again to FIG. 1, if a match is found between the recent payment card account receipt data and purchase transaction data in the transactional cardholder database 108, then the cardholder modeling server computer 102 selects a portion of the payment card account data from the transactional cardholder database 108 that corresponds to a time period specified in the self-reported survey data. For example, if the cardholder survey was completed by the cardholder panel member in November, 2012 and was directed to consumer survey questions concerning intended purchases for the upcoming holiday season (i.e., the 2012 Christmas season), then the portion of the payment card account data selected by the cardholder modeling computer may be all cardholder purchase transaction receipts for purchases that occurred between Nov. 15, 2012 and Dec. 31, 2012 for that cardholder payment account. In some embodiments, the cardholder modeling server computer 102 then generates a cardholder report, which is identified by the unique cardholder ID. The cardholder report may include information that compares the consumer survey responses (by the cardholder) to questions that represented intended cardholder purchasing behavior (as of November, 2012) to the selected portion of purchase transaction receipts in the transactional cardholder database that represents actual cardholder purchasing behavior (for the 2012 Christmas season). For example, the cardholder may have indicated in a survey question response that he or she intended to purchase “X” dollars of consumer electronic devices at consumer electronic merchants as holiday presents by the end of 2012. However, the purchase transaction receipts of that cardholder from Nov. 15 through Dec. 31, 2012 show that no purchases were made from consumer electronics merchants, and instead that item purchases were made from other types of merchants. However, a second cardholder panel member completing the same cardholder survey (completed in November, 2012) indicated in a survey question response that he intended to purchase “Y” dollars of consumer electronic devices at consumer electronic merchants as holiday presents by the end of 2012. The purchase transaction receipts for the second cardholder panel member from Nov. 15 through Dec. 31, 2012 show that the second cardholder panel member purchased $Y+$200 from consumer electronics merchants, thus signifying that the second cardholder panel member actually exceeded his predicted spending. In some cases the first and second cardholder panel members may have some characteristics in common, but may also belong to different consumer segments (such as belonging to different age groups).

In some embodiments, the cardholder modeling computer includes software and/or instructions configured to provide consumer purchasing behavior prediction data. For example, the cardholder modeling computer may be configured to aggregate cardholder purchase transaction data for a plurality of panel members, compare and/or correlate survey responses with actual cardholder transaction receipt data for a particular time period, and then generate a cardholder report that provides predictions for future consumer and/or cardholder purchasing behavior. In some embodiments, the cardholder modeling computer may generate a plurality of cardholder reports, aggregate the cardholder reports in accordance with predefined consumer segments, and then provide a prediction of future consumer purchasing behavior for one or more selected consumer segments. The consumer segments may correspond to, for example, cardholders having a predetermined family income level, cardholders who are in a selected geographic location, cardholders of a particular age group, and the like. In other embodiments, the cardholder modeling computer may be operable to generate multiple cardholder reports of panel members and then group the cardholder reports into a plurality of consumer segments. The segments may be based on, for example, one or more of demographic data, economic data and geographic data. In addition, based on one or more of the cardholder reports, the cardholder modeling computer may be configured to create or generate one or more financial products predicted to be of interest to consumers of one or more consumer segments. Such financial products may be of a type that could be provided, for example, by one or more issuer financial institutions 110A-110N. In some embodiments, the cardholder modeling computer 102 is configured to transmit one or more reports and/or documents and/or files containing proposals for creating such financial products to one or more of the financial institutions 110A-110N by using one or more secured networks (not shown), or by using a secure file transfer protocol (FTP) to transfer files over the internet 112.

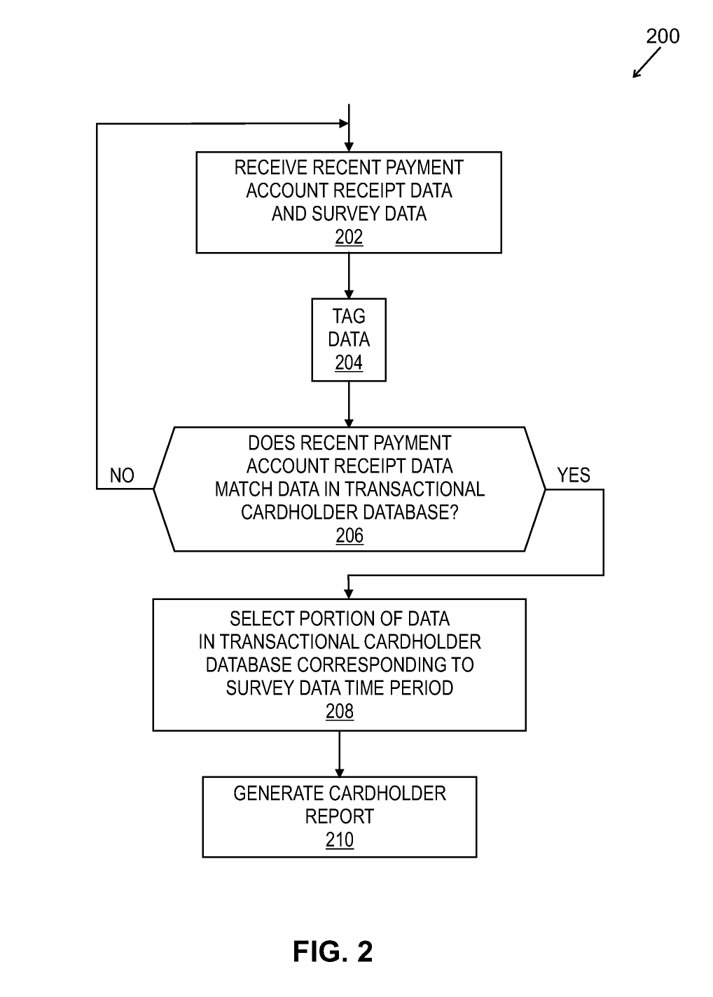

FIG. 2 is a flowchart of a consumer receipt harvesting process 200 in accordance with some embodiments. In particular, a cardholder modeling computer receives 202 recent payment card account receipt data and self-reported survey data responses of a panel respondent member who agreed to provide the data (for example, a cardholder panel member who opted-in to the receipt harvesting service). The cardholder modeling computer then tags 204 the recent payment card account receipt data and the self-reported survey data with a unique cardholder identifier (ID), and compares 206 the recent payment card account receipt data with receipt data in the transactional cardholder database. If there is no match, then the process branches back to step 202 wherein data is received from another cardholder panel member. But if there is a match in step 206, meaning that the recent payment card account receipt data received from the cardholder matches receipt data in the transactional cardholder database, then the cardholder modeling computer selects 208 a portion of the payment card account data of the transactional cardholder database which is associated with the panel respondent member that corresponds to a time period specified in the self-reported survey data. In some embodiments, the cardholder modeling computer then generates 210 a cardholder report or file, identified by the unique cardholder ID, that compares the self-reported survey data (representing intended cardholder purchasing behavior) to the selected portion of the payment card account data (that represents actual cardholder purchasing behavior) of the cardholder transactional database.

In some embodiments, the process may also include generating a cardholder report or file that predicts future behavior of the cardholder based on the comparison of the actual cardholder purchase transaction receipts to the cardholder's survey question response data. In some implementations, the method may also include generating a plurality of cardholder reports, aggregating cardholder reports in accordance with predefined consumer segments, and then providing a prediction of future consumer purchasing behavior for a selected consumer segment or combination of consumer segments. For example, a selected consumer segment may correspond to income level, location, age group, and the like. In addition, in some embodiments the process may further include generating many cardholder reports or files (associated with multiple cardholder panel members), and then grouping cardholder reports into a plurality of consumer segments based on one or more of demographic data, economic data and geographic data. In addition, the cardholder modeling computer may be configured to create one or more financial products predicted to be of interest to consumers of one or more consumer segments.

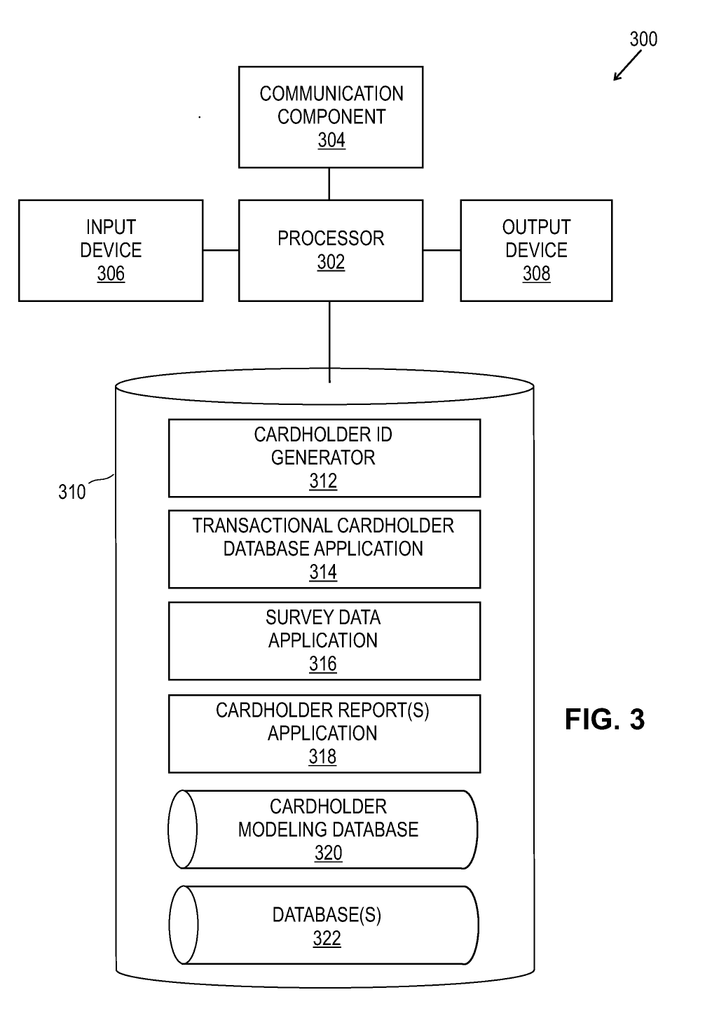

FIG. 3 is a block diagram of an embodiment of a cardholder modeling computer 300 according to an embodiment. The cardholder modeling computer may be conventional in its hardware aspects but may be controlled by software to cause it to operate in accordance with aspects of the methods presented herein. In particular, the cardholder modeling computer 300 may include a computer processor 302 operatively coupled to a communication component 304, an input device 306, an output device 308, and a storage device 310.

The computer processor 302 may constitute one or more conventional processors. Processor 302 operates to execute processor-executable steps, contained in program instructions described herein, so as to control the cardholder modeling computer 300 to provide desired functionality.

Communication component 304 may be used to facilitate communication with, for example, other devices such as computer servers and the like. Communication device 304 may thus, for example, have capabilities for engaging in data communications over conventional computer-to-computer data networks and/or for engaging in communications via the Internet. Such data communications may be in digital form and/or in analog form.

Input device 306 may comprise one or more of any type of peripheral device typically used to input data into a computer. For example, the input device 306 may include a keyboard and a mouse and/or a touchpad or touch screen that may be used, for example, by a systems engineer or other personnel authorized to, for example, perform cardholder modeling computer system maintenance or other tasks. The output device 308 may comprise, for example, a display and/or a printer and/or an audio speaker.

Storage device 310 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices, Read Only Memory (ROM) devices, and/or flash memory devices. Any one or more of the listed storage devices may be referred to as a “memory”, “storage”, a “storage medium”, and/or a non-transitory computer-readable medium.

Storage device 310 stores one or more programs for controlling processor 302. The programs comprise program instructions that contain processor-executable process steps of the cardholder modeling computer 300, including, in some cases, process steps that constitute processes provided in accordance with principles of the processes presented herein.

The programs may include a cardholder ID generator application 312 that manages a process by which the cardholder modeling computer generates a unique ID for tagging the recent payment account receipt data and survey data provided by a cardholder panel member. In some embodiments, a random number generator may be utilized along with a checking program to ensure that any particular cardholder ID is unique.

The storage device 310 may also store a transactional cardholder database application 314 for controlling the cardholder modeling computer 300 to compare the received recent cardholder receipt data to purchase receipt data stored in the cardholder database, and for determining if a match occurs. A survey data application 316 is also included for controlling the cardholder modeling computer 300 to select, if a match does occur, a portion of the payment card account data of the transactional cardholder database which is associated with the panel respondent member that corresponds to a time period specified in the self-reported survey data. In addition, a cardholder report(s) application 318 is included for controlling the cardholder modeling computer to generate one or more cardholder reports or electronic files, identified by the unique cardholder ID. For example, a cardholder report or electronic file may include a comparison of the self-reported survey data (representing intended cardholder purchasing behavior) for a particular panel member to the selected portion of the payment card account data (that represents actual cardholder purchasing behavior) of the cardholder transactional database for that panel member, so that a determination can be made between what the cardholder was thinking regarding future purchases versus what the cardholder actually did (the purchases actually made). Such cardholder reports or electronic files can be made on an individual basis, or may be made based on aggregated data from two or more panel members.

In addition, the storage device 310 may include a cardholder modeling database 320 that stores panel member purchase receipt data and survey response date. One or more additional databases 322 may also be maintained by the cardholder modeling computer 300 on the storage device 310.

The application programs of the cardholder modeling computer 300, as described above, may be combined in some embodiments, as convenient, into one, two or more application programs. Moreover, the storage device 310 may store other programs or applications, such as one or more operating systems, device drivers, database management software, web hosting software, and the like.

With regard to the flowcharts provided herein, it should be understood that the illustrated methods are not limited to the order shown. Rather, embodiments of the methods may be performed in any order that is practicable. For that matter, unless stated otherwise, any method disclosed herein may be performed in any order that is practicable. Notably, some embodiments may employ one or more portions of the methods illustrated herein without one or more other portions of the methods.

As used herein and in the appended claims, the term “payment card account” includes a credit card account or a deposit account that the account holder may access using a debit card. The term “payment card account number” or “financial account number” includes a number that identifies a payment card account or a number carried by a payment card, or a number that is used to identify an account in a payment system that handles debit card and/or credit card transactions or to route a transaction in a payment system that handles debit card and/or credit card transactions. The term “payment card” includes a credit card or a debit card (including a pre-paid debit card). The term “payment card account” also includes an account to which a payment card account number is assigned. Thus a payment card account may include an account to which payment transactions may be routed by a payment system that handles debit card and/or credit card transactions, even if the account in question is not eligible to be charged for purchase transactions or other transactions. A payment card account may also include an account from which payment transactions may be routed by a payment system that handles debit card and/or credit card transactions, even if the account in question is not customarily used, or is not eligible, to be charged for purchase transactions.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method, comprising:
receiving, by a computer, recent payment card account receipt data and self-reported survey data of a panel respondent member;
tagging, by the computer, the recent payment card account receipt data and self-reported survey data with a unique cardholder identifier (ID);
determining, by the computer, that the recent payment card account receipt data matches payment card account receipt data stored in a transactional cardholder database;
selecting, by the computer, a portion of the matched payment card account receipt data corresponding to a time period specified in the self-reported survey data of the panel respondent member; and
generating, by the computer, a cardholder report identified by the unique cardholder ID comprising a comparison of the self-reported survey data representing intended cardholder purchasing behavior to the selected portion of the matched payment card account data that represents actual cardholder purchasing behavior.

2. The method of claim 1, wherein the self-reported survey data comprises cardholder responses to survey questions concerning the cardholder's intended purchasing behavior for a particular time period.

3. The method of claim 1, further comprising generating, based on the cardholder report, a prediction of future behavior of the cardholder.

4. The method of claim 1, further comprising:
generating a plurality of cardholder reports based on self-reported survey data of a plurality of panel respondent members;
aggregating the plurality of cardholder reports into at least one cardholder segment report in accordance with predefined consumer segments; and
providing, by the computer, a prediction of future consumer purchasing behavior for a selected consumer segment.

5. The method of claim 4, wherein the predefined consumer segments are based on at least one of demographic data, economic data and geographic data.

6. The method of claim 1, further comprising:
generating a plurality of cardholder reports; and
grouping, by the computer, cardholder reports into a plurality of consumer segments based on at least one of demographic data, economic data and geographic data.

7. The method of claim 6, further comprising:
creating, by the computer based on at least one group of cardholder reports, at least one financial product predicted to be of interest to consumers of that consumer segment.

8. An apparatus comprising:
a processor;
a communication component operably connected to the processor; and
a non-transitory storage device operably connected to the processor, wherein the non-transitory storage device includes instructions configured to instruct the processor to:
receive recent payment card account receipt data and self-reported survey data of a panel respondent member;
tag the recent payment card account receipt data and self-reported survey data with a unique cardholder identifier (ID);
determine that the recent payment card account receipt data matches payment card account receipt data stored in a transactional cardholder database;
select a portion of the matched payment card account receipt data corresponding to a time period specified in the self-reported survey data of the panel respondent member; and
generate a cardholder report identified by the unique cardholder ID comprising a comparison of the self-reported survey data representing intended cardholder purchasing behavior to the selected portion of the matched payment card account data that represents actual cardholder purchasing behavior.

9. The apparatus of claim 8, further comprising instructions stored in the non-transitory storage device and configured to cause the processor to generate, based on the cardholder report, a prediction of future behavior of the cardholder.

10. The apparatus of claim 8, further comprising instructions stored in the non-transitory storage device and configured to cause the processor to:
generate a plurality of cardholder reports based on self-reported survey data of a plurality of panel respondent members;
aggregate the plurality of cardholder reports into at least one cardholder segment report in accordance with predefined consumer segments; and
provide a prediction of future consumer purchasing behavior for a selected consumer segment.

11. The apparatus of claim 8, further comprising instructions stored in the non-transitory storage device and configured to cause the processor to:
generate a plurality of cardholder reports; and
group cardholder reports into a plurality of consumer segments based on at least one of demographic data, economic data and geographic data.

12. The apparatus of claim 11, further comprising instructions stored in the non-transitory storage device and configured to cause the processor to create, based on at least one group of cardholder reports, at least one financial product predicted to be of interest to consumers of that consumer segment.

13. A non-transitory computer-readable medium storing instructions configured to instruct a processor to:
receive recent payment card account receipt data and self-reported survey data of a panel respondent member;
tag the recent payment card account receipt data and self-reported survey data with a unique cardholder identifier (ID);
determine that the recent payment card account receipt data matches payment card account receipt data stored in a transactional cardholder database;
select a portion of the matched payment card account receipt data corresponding to a time period specified in the self-reported survey data of the panel respondent member; and
generate a cardholder report identified by the unique cardholder ID comprising a comparison of the self-reported survey data representing intended cardholder purchasing behavior to the selected portion of the matched payment card account data that represents actual cardholder purchasing behavior.

14. The non-transitory computer-readable medium of claim 13, storing further instructions configured to instruct the processor to generate, based on the cardholder report, a prediction of future behavior of the cardholder.

15. The non-transitory computer-readable medium of claim 13, storing further instructions configured to instruct the processor to:
generate a plurality of cardholder reports based on self-reported survey data of a plurality of panel respondent members;
aggregate the plurality of cardholder reports into at least one cardholder segment report in accordance with predefined consumer segments; and
provide a prediction of future consumer purchasing behavior for a selected consumer segment.

16. The non-transitory computer-readable medium of claim 13, storing further instructions configured to instruct the processor to:
generate a plurality of cardholder reports; and
group cardholder reports into a plurality of consumer segments based on at least one of demographic data, economic data and geographic data.

17. The non-transitory computer-readable medium of claim 16, storing further instructions configured to instruct the processor to create, based on at least one group of cardholder reports, at least one financial product predicted to be of interest to consumers of that consumer segment.
